(19) United States
(12) Patent Application Publication
(10) Pub. No.: US 2026/0169589 A1
(43) Pub. Date: Jun. 18, 2026

(54) TOUCH SENSOR DRIVING CIRCUIT AND DISPLAY DEVICE INCLUDING THE SAME

(71) Applicant: LG Display Co., Ltd., Seoul (KR)

(72) Inventors: Byung Woong KIM, Paju-si (KR); Sung Uk BYUN, Paju-si (KR); Jun Su KIM, Paju-si (KR); Ki Taek OH, Paju-si (KR)

(73) Assignee: LG Display Co., Ltd., Seoul (KR)

(21) Appl. No.: 19/332,732

(22) Filed: Sep. 18, 2025

(30) Foreign Application Priority Data
Dec. 18, 2024 (KR) 10-2024-0189481

(51) Int. Cl. G06F 3/041

(52) U.S. Cl. CPC G06F 3/04182; G06F 3/04164

(57) ABSTRACT

Disclosed is a touch sensor driving circuit and a display device including the same. The touch sensor driving circuit includes: a plurality of sensor lines; a voltage compensation circuit electrically connected to the sensor lines; and a sensor driver configured to supply a pulse of a touch sensor driving signal to the sensor lines during a first period, and to supply an output voltage of the voltage compensation circuit to the sensor lines during a second period. The voltage compensation circuit includes an input resistor which is electrically connected to the sensor lines during the second period.

### CROSS-REFERENCE TO RELATED APPLICATION

This application claims priority to and the benefit of Korean Patent Application No. 10-2024-0189481, filed Dec. 18, 2024, the disclosure of which is incorporated herein by reference in its entirety.

### BACKGROUND

### Technical Field

The present disclosure relates to a touch sensor driving circuit and a display device including the same.

### Description of the Related Art

In-cell touch sensors are increasingly being adopted in a variety of display devices, including liquid crystal displays and electroluminescent displays. The in-cell touch sensor may be integrated into a display panel in which images are reproduced.

The display panel integrated with the in-cell touch sensor does not require a separate touch panel, and thus the thickness of the display device may be reduced, the overall weight may be decreased, and the manufacturing cost may be lowered. Since the display panel also does not require an additional touch electrode layer, the light transmittance and image quality of the display panel may be improved.

Since the touch sensor driving circuit and the display pixel driving circuit are integrated, the driving signals of the in-cell touch sensor and pixels may interfere with each other. To reduce such signal interference, the in-cell touch sensor and the pixels may be driven in a time-division manner. In order to maintain touch sensitivity and accuracy above a certain level, the driving frequency of the in-cell touch sensor may be increased. Such high-frequency signals may increase electromagnetic waves that cause electromagnetic interference (EMI). EMI noise may adversely affect surrounding devices, resulting in degradation of image quality of an image reproduced on the display panel and malfunction of the surrounding devices.

### BRIEF SUMMARY

The present disclosure solves, among others, electromagnetic interference (EMI) problem of high-frequency signals.

The present disclosure provides a touch sensor driving circuit capable of reducing EMI, and a display device including the same.

The features of the present disclosure are not limited to those described above, and other features not explicitly mentioned will be clearly understood by those skilled in the art from the following description.

A touch sensor driving circuit according to an embodiment includes: a plurality of sensor lines; a voltage compensation circuit electrically connected to the sensor lines; and a sensor driver configured to supply a pulse of a touch sensor driving signal to the sensor lines during a first period, and to supply an output voltage of the voltage compensation circuit to the sensor lines during a second period. The voltage compensation circuit includes an input resistor which is electrically connected to the sensor lines during the second period.

A DC voltage may be applied to the input resistor during the first period.

The touch sensor driving circuit may further include: a plurality of switching elements connected to the sensor lines. The switching elements may be configured to be turned on during the second period to connect the sensor lines to each other and to connect the sensor lines to the input resistor, and may be configured to electrically disconnect the sensor lines from each other and to electrically disconnect the sensor lines from the input resistor during the first period.

The voltage compensation circuit may include: an operational amplifier including an inverting input terminal connected to the input resistor, a non-inverting input terminal to which the DC voltage is applied, and an output terminal connected to the sensor driver; and a feedback resistor connected between the inverting input terminal and the output terminal of the operational amplifier.

The voltage compensation circuit may include a transistor configured to supply the DC voltage to the input resistor during the first period and to be turned off during the second period in response to a touch enable signal.

The transistor may include a gate electrode to which the touch enable signal is inputted, a first electrode connected to a node between the sensor lines and the input resistor, and a second electrode to which the DC voltage is inputted.

The voltage compensation circuit may include a multiplexer configured to supply the DC voltage to the input resistor during the first period and to connect the sensor lines to the input resistor during the second period in response to a touch enable signal.

A touch sensor driving circuit according to another embodiment includes: a plurality of sensor lines; an inverting amplifier electrically connected to the sensor lines; and a sensor driver configured to supply a pulse of a touch sensor driving signal to the sensor lines during a first period, and to supply an output voltage of the inverting amplifier to the sensor lines during a second period.

A gain of the inverting amplifier may be lower in the first period than in the second period.

The inverting amplifier may include: an input resistor electrically connected to the sensor lines; an operational amplifier including an inverting input terminal connected to the input resistor, a non-inverting input terminal to which a DC voltage is applied, and an output terminal; a first transistor and a first feedback resistor connected in series between the output terminal and the inverting input terminal of the operational amplifier; and a second transistor and a second feedback resistor connected in series between the output terminal and the inverting input terminal of the operational amplifier.

A resistance value of the first feedback resistor may be smaller than that of the second feedback resistor. The first transistor may be turned on during the first period to connect the first feedback resistor to the inverting input terminal. The second transistor may be turned on during the second period to connect the second feedback resistor to the inverting input terminal.

A display device according to one embodiment includes: a display panel in which a plurality of data lines, a plurality of gate lines, a plurality of sensor lines, a plurality of pixels, a plurality of divided electrodes connected to the pixels and the sensor lines, and a plurality of in-cell touch sensors connected to the sensor lines are arranged; a voltage compensation circuit electrically connected to the sensor lines; a sensor driver configured to supply a pulse of a touch sensor driving signal to the sensor lines during a first period, and supply an output voltage of the voltage compensation circuit to the sensor lines during a second period; and a pixel driver configured to supply a data voltage of pixel data to the data lines during the second period. The voltage compensation circuit includes an input resistor which is electrically connected to the sensor lines during the second period.

A display device according to another embodiment includes: a display panel in which a plurality of data lines, a plurality of gate lines, a plurality of sensor lines, a plurality of pixels, a plurality of divided electrodes connected to the pixels and the sensor lines, and a plurality of in-cell touch sensors connected to the sensor lines are arranged; an inverting amplifier electrically connected to the sensor lines; a sensor driver configured to supply a pulse of a touch sensor driving signal to the sensor lines during a first period and to supply an output voltage of the inverting amplifier to the sensor lines during a second period; and a pixel driver configured to supply a data voltage of pixel data to the data lines during the second period.

The present disclosure may reduce EMI by blocking the touch sensor driving signal applied to the voltage compensation circuit during a touch sensing period.

The present disclosure may remove a ripple component applied to a common electrode shared by the in-cell touch sensors and the pixels during a display period, and may reduce distortion of the touch sensor driving signal by blocking the touch sensor driving signal applied to an input terminal of the voltage compensation circuit during the touch sensing period.

The effects of the present disclosure are not limited to those described above, and other effects not explicitly mentioned will be clearly understood by those skilled in the art from the description of the present disclosure.

### BRIEF DESCRIPTION OF THE SEVERAL VIEWS OF THE DRAWINGS

The above and other objects, features, and advantages of the present disclosure will become more apparent to those of ordinary skill in the art by describing exemplary embodiments thereof in detail with reference to the attached drawings, in which:

FIGS. 1 and 2 are diagrams illustrating a display device according to one embodiment of the present disclosure;

FIG. 3 is a circuit diagram illustrating an example of an in-cell touch sensor and a driving circuit thereof according to one embodiment of the present disclosure;

FIG. 4 is a waveform diagram illustrating an example of a time-division driving method of a pixel and an in-cell touch sensor;

FIG. 5 is a circuit diagram illustrating a voltage compensation circuit according to one embodiment of the present disclosure;

FIG. 6 is a circuit diagram illustrating a voltage compensation circuit according to another embodiment of the present disclosure; and

FIG. 7 is a circuit diagram illustrating a voltage compensation circuit according to still another embodiment of the present disclosure.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” and “having,” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, by using terms such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, by using terms such as “after,” “following,” “next to,” “before,” or the like, it may not be continuous on a time base unless “immediately” or “directly” is used.

The terms “first,” “second,” and the like may be used to distinguish components from each other, but the functions or structures of the components are not limited by ordinal numbers or component names in front of the components.

The voltage compensation circuit may include one of more transistors. A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor), since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

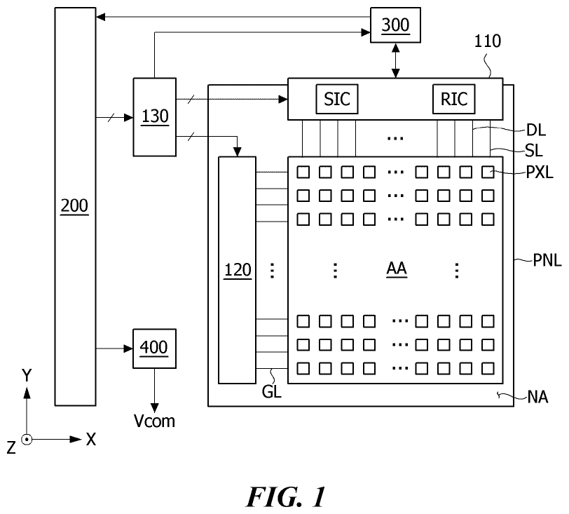

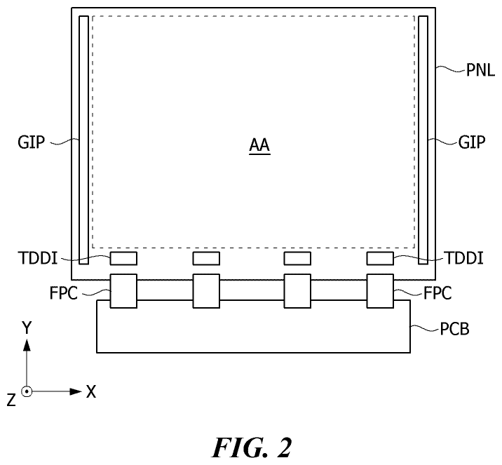

FIGS. 1 and 2 are diagrams illustrating a display device according to one embodiment of the present disclosure.

Referring to FIG. 1, the display device according to an embodiment of the present disclosure includes a display panel PNL, a pixel driving circuit for writing pixel data to pixels PXL of the display panel PNL, a touch sensor driving circuit to drive in-cell touch sensors, and a power supply 400.

The display panel PNL may be, but is not limited to, a panel having a rectangular structure with a length (or width) in the X-axis direction, a length in the Y-axis direction, and a thickness in the Z-axis direction. A display area AA of the display panel PNL includes a pixel array for displaying an input image thereon. The pixel array includes a plurality of data lines DL, a plurality of sensor lines SL, a plurality of gate lines GL intersecting the data lines DL and the sensor lines SL, a plurality of pixels PXL, and in-cell-touch sensors integrated with the pixels PXL. A plurality of divided electrodes connected to the pixels PXL and the sensor lines SL may be further arranged in the display panel PNL.

The data lines DL are arranged in the form of long wires along the Y-axis direction of the display panel PNL and are electrically connected to data channels of a data driver 110. The sensor lines SL are arranged on the display panel PNL in parallel with the data lines DL and may be connected to sensor channels of the data driver 110. The gate lines GL are arranged in the form of long wires along the X-axis direction of the display panel PNL and intersect with the data lines DL and sensor lines SL. The gate lines GL are electrically connected to the output terminals of the gate driver 120.

Each of the pixels PXL may be divided into a red sub-pixel, a green sub-pixel, and a blue sub-pixel for color implementation. Each of the pixels may further include a white sub-pixel. Each of the sub-pixels includes a pixel circuit. The pixel circuit may include a pixel electrode, and one or more transistors and capacitors. The pixel circuit is connected to a data line DL and a gate lines GL. The transistor may be implemented as a thin film transistor (TFT).

A pixel circuit of a liquid crystal display device may apply a data voltage, the voltage level of which varies according to a grayscale value of pixel data, to the pixel electrode, and drive liquid crystal molecules of a liquid crystal cell between the pixel electrode and a common electrode, thereby varying the transmittance of the display panel according to the grayscale value of the pixel data. A pixel circuit of an electroluminescent display device supplies a current that varies according to a grayscale value of pixel data to a light-emitting element disposed in each sub-pixel, for example, an organic light-emitting diode (OLED), to turn on the light-emitting element with brightness corresponding to the grayscale value of the pixel data. In the following, a display panel in which in-cell touch sensors are integrated will be described with a focus on the liquid crystal display device, but it should be noted that the present disclosure is not limited thereto.

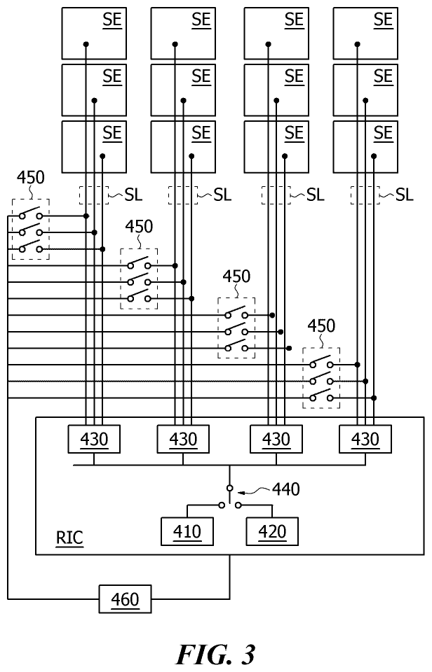

The in-cell touch sensors may be implemented as capacitive type touch sensors, for example, mutual capacitance sensors or self-capacitance sensors. Self-capacitance is formed along the conductor lines of a single layer formed in one direction. Mutual capacitance is formed between two orthogonal conductor lines. In the following embodiments, the embodiments will be described with a focus on a self-capacitive type touch sensor as shown in FIG. 3, but the present disclosure is not limited thereto.

The pixel driving circuit and the touch sensor driving circuit may be integrated. For example, the data driver 110 may include a pixel driver SIC and a sensor driver RIC. A timing controller 130 and a touch sensor controller 300 may share a synchronization signal.

The pixel driving circuit writes the pixel data of the input image to the pixels PXL of the display panel PNL during a display period under the control of the timing controller 130. The pixel driving circuit includes the pixel driver SIC of the data driver 110, and a gate driver 120.

The pixel driver SIC includes a plurality of data channels electrically connected to the data lines DL. The pixel driver SIC receives the pixel data of the input image received as digital signals from the timing controller 130 during the display period. The pixel driver SIC may be configured to supply a data voltage of pixel data to the data lines DL during the display period. Each of the data channels of the pixel driver SIC uses a digital-to-analog converter (DAC) to convert the pixel data of the input image into a gamma compensated voltage and outputs a data voltage of the pixel data. A gamma reference voltage is divided through a voltage divider circuit into gamma compensated voltage for each grayscale. The gamma compensated voltages for each grayscale are provided to the DAC of the pixel driver SIC. The data voltage output from the DAC may be output through an output buffer and supplied to the data lines DL during the display period.

The gate driver 120 may be arranged in a non-display area NA on at least one of the right and left sides outside the display area AA in the display panel PNL, or at least a portion thereof may be arranged within the display area AA. The gate driver 120 may be located in the non-display areas NA on both sides of the display panel PNL with the display area AA of the display panel interposed therebetween, and may supply pulses of the gate signals from the both ends of the gate lines GL in a double feeding method. In another embodiment, the gate driver 120 may be disposed in at least one of the left and right non-display areas NA of the display panel PNL and may supply gate signals to the gate lines GL in a single feeding method. The gate driver 120 sequentially outputs pulses of the gate signals to the gate lines GL under the control of the timing controller 130. The gate driver 120 may sequentially supply the pulses of the gate signals to the gate lines GL by shifting the pulses of the gate signals (or scan signals) using shift registers. In FIG. 2, “GIP” denotes the gate driver 120 disposed in the display panel PNL.

The touch sensor driving circuit includes a touch sensor controller 300, and a sensor driver RIC in the data driver 110. The touch sensor driving circuit drives the in-cell touch sensors during a touch sensing period under the control of the touch sensor controller 300 to provide touch data (XY), including position information or coordinate information of the touch input, to the host system 200.

The touch sensor controller 300 compares the touch raw data received from the sensor driver RIC with a preset threshold value, and outputs the touch raw data above the threshold value as touch data indicating the touch input.

The touch sensor controller 300 drives the sensor driver RIC by supplying a touch enable signal (TEN) defining a touch sensor driving timing and an ADC (Analog to Digital Converter) clock to the sensor driver RIC. The touch sensor controller 300 may be implemented as a micro control unit (MCU), but is not limited thereto.

A host system 200 may scale an image signal from a video source to match the resolution of the display panel PNL, and it may then transmit the scaled image signal and a timing control signal to the timing controller 300. The host system 200 may perform commands associated with the touch data received from the touch sensor controller 300 or execute applications.

The timing controller 130 may receive digital video data of an input image from the host system 200 and a timing signal synchronized with the digital video data, and may control the operation timing of the data driver 110 and the gate driver 120 based on the received digital video data and the timing signal. The timing signal may include a vertical synchronization signal (Vsync), a horizontal synchronization signal (Hsync), and a data enable signal (DE). A vertical period and a horizontal period may be determined by counting the data enable signal (DE), and thus the vertical synchronization signal (Vsync) and the horizontal synchronization signal (Hsync) may be omitted. The horizontal synchronization signal (Hsync) and the data enable signal (DE) have a period of one horizontal period (1H).

The timing controller 130 generates a data timing control signal for controlling the operation timing of the data driver 110 and a gate timing control signal for controlling the operation timing of the gate driver 120. A level shifter, not shown in this drawing, may shift the voltage level of the gate timing control signal and deliver it to the gate driver 120.

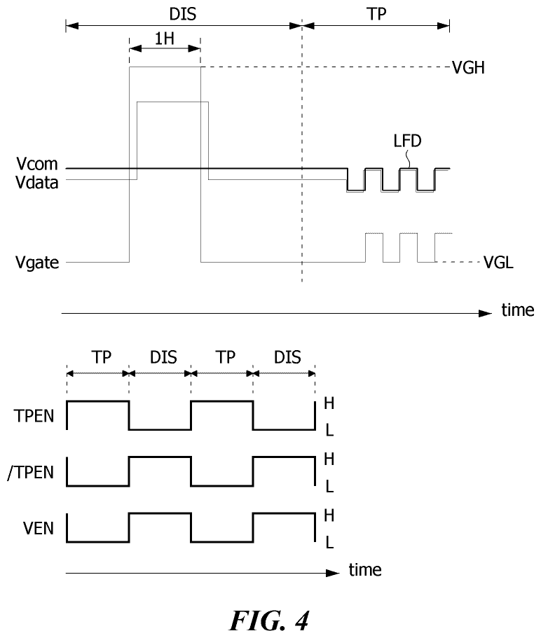

The power supply 400 receives a direct current (DC) voltage from the main power source of the host system 200 using a DC-DC converter and generates a DC voltage (or constant voltage) for driving the pixel driving circuit and the touch sensor driving circuit. The DC-DC converter may include a charge pump, a regulator, a buck converter, a boost converter, a buck-boost converter, or the like. The power supply 400 may regulate the DC voltage input from the host system 200 to generate DC voltages such as a gamma reference voltage, a gate-high voltage (VGH, FIG. 4), a gate-low voltage (VGL, FIG. 4), a half-VDD (HVDD), and a common voltage Vcom. The half-VDD voltage may be one-half the voltage of the power supply voltage (VDD) and may be used as the output buffer driving voltage of the pixel driver SIC. In FIG. 1, “Vcom” is the common voltage applied to the common electrodes used as the electrodes of the in-cell touch sensors. The common voltage Vcom may be, but is not limited to, a DC voltage (or constant voltage). The gate-high and gate-low voltages may be used as pulse voltages of the gate signals. The circuit of the power supply 400 may be implemented as a power management integrated circuit (PMIC), but is not limited thereto.

Referring to FIG. 2, the data driver 110 may be implemented as a touch and display driver integration TDDI IC chip in which the pixel driver SIC and the sensor driver RIC are embedded. One or more TDDIs may be bonded onto a substrate of the display panel PNL through a chip on glass (COG) process, and may be electrically connected to the data lines DL and the sensor lines SL.

A flexible film, e.g., one or more flexible printed circuits FPC, having wires formed thereon may be bonded onto the display panel PNL. The FPC may be connected to a connector of a printed circuit board PCB. The timing controller 130, the touch sensor controller 300, the power supply 400, and a voltage compensation circuit 460 (see FIG. 3) may be positioned on the FPC or the PCB.

During the touch sensing period in which the in-cell touch sensors are driven in the display panel PNL integrated with the in-cell touch sensors, EMI noise caused by a high-frequency touch sensor driving signal for driving the in-cell touch sensors during the touch sensing period may be measured on the FPC and the PCB. Such EMI noise may be measured at levels exceeding an allowable limit. The present disclosure may reduce the EMI noise on the FPC and the PCB by blocking the touch sensor driving signal applied to the voltage compensation circuit during the touch sensing period.

FIG. 3 is a circuit diagram illustrating an example of an in-cell touch sensor and a driving circuit thereof according to one embodiment of the present disclosure. FIG. 4 is a waveform diagram illustrating an example of a time-division driving method of a pixel and an in-cell touch sensor. In FIG. 4, TPEN, /TPEN, and VEN are enable signals (or synchronization signals) having different voltage levels during a display period DIS and a touch sensing period TP. A first touch enable signal TPEN, a second touch enable signal /PEN, and a voltage enable signal VEN are distinguished for simplicity of description, and may be generated as a single signal. The second touch enable signal /PEN may be a signal whose phase is inverted with respect to the first touch enable signal TPEN. These signals TPEN, /TPEN, and VEN may be generated from the timing controller 130 or the touch sensor controller 300, or may be generated from the timing controller 130 and transmitted to the touch sensor controller 300. In FIG. 4, VGH denotes a gate high voltage, and VGL denotes a gate low voltage.

Referring to FIGS. 3 and 4, the touch sensors of an in-cell type may include electrodes divided in a predetermined size from a common electrode SE of the pixels.

A plurality of switching elements 450 connected to the sensor lines SL may be arranged in the display panel PNL. Each of the switching elements 450 may be implemented as a transistor that is turned on or off in response to a voltage of the voltage enable signal VEN. The switching elements 450 may be connected to all of the sensor lines SL.

During the display period DIS, the switching elements 450 are turned on in response to a first voltage H of the voltage enable signal VEN. In this case, the divided common electrodes SE are short-circuited to each other through the switching elements 450 and the sensor lines SL during the display period DIS, and are electrically connected to each other as a single electrode. The sensor driver RIC transmits the common voltage Vcom from the power supply 400 or an output voltage of the voltage compensation circuit 460 to the sensor lines SL during the display period DIS. Accordingly, during the display period DIS, since the common voltage Vcom is applied to the shorted common electrodes SE, the common voltage Vcom may be applied to the pixels PXL at a uniform voltage without deviation across the entire display area AA of the display panel PNL.

During the touch sensing period TP, the switching elements 450 are turned off in response to a second voltage L of the voltage enable signal VEN. In this case, the sensor lines SL are electrically disconnected from each other. The sensor driver RIC supplies a touch sensor driving signal LFD, which is generated as high-frequency pulses, to the sensor lines SL during the touch sensing period TP. Accordingly, the divided common electrodes SE are electrically disconnected from one another during the touch sensing period TP and are charged with electric charges by a pulse voltage of the touch sensor driving signal LFD supplied through the corresponding sensor lines SL. Since the capacitance of the divided common electrodes SE in the in-cell touch sensor is individually separated, it may vary before and after a touch input, allowing the touch input to be sensed. When a finger or pen touches or approaches the common electrode SE, a change in the capacitance of the common electrode increases, and this capacitance change is recognized as a touch input.

The display device may further include the voltage compensation circuit 460. The voltage compensation circuit 460 may be connected between the switching elements 450 and the sensor driver RIC, but is not limited thereto. For example, the voltage compensation circuit 460 may be connected between the sensor lines SL and the sensor driver RIC. When a ripple occurs in the common voltage Vcom applied to the common electrodes SE connected to the sensor lines SL, the voltage compensation circuit 460 outputs an inverted signal of the ripple using an inverting amplifier. The output voltage of the voltage compensation circuit 460 is applied to the common electrodes SE, to which the common voltage Vcom is supplied, through the sensor driver RIC, thereby removing the ripple component from the common voltage Vcom. Accordingly, the common voltage Vcom may be maintained as a ripple-free DC voltage or constant voltage during the display period DIS across the entire display area AA of the display panel PNL.

The sensor driver RIC includes a first driver 410, a second driver 420, a first switching element 430, and a second switching element 440. The first and second switching elements 430 and 440 may be implemented using a plurality of transistors or a multiplexer.

The first driver 410 outputs pulses of the touch sensor driving signal LFD in synchronization with pulses of a pulse width modulation (PWM) signal received from the touch sensor controller 300 during the touch sensing period TP. The second driver 420 supplies the common voltage Vcom, from which a ripple component has been removed by the output voltage of the voltage compensation circuit 460, to the sensor lines SL.

Under the control of the touch sensor controller 300, the second switching element 440 connects the output terminal of the second driver 420 to the input terminals of the first switching elements 430 during the display period DIS, and connects the output terminal of the first driver 410 to the input terminals of the first switching elements 430 during the touch sensing period TP. Under the control of the touch sensor controller 300, the first switching elements 430 supply the common voltage Vcom inputted through the second switching element 440 to the sensor lines SL during the display period DIS, and supply the touch sensor driving signal LFD inputted through the first switching element 430 to the sensor lines SL during the touch sensing period TP.

As illustrated in FIG. 4, during the display period DIS, the common voltage Vcom as a DC voltage is applied to the sensor lines SL, and during the touch sensing period TP, the touch sensor driving signal LFD with continuous pulses is applied to the sensor lines SL. A pulse of a gate signal Vgate is applied to the gate line GL during the display period DIS, and pulses having the same phase as those of the touch sensor driving signal LFD are applied to the gate line GL during the touch sensing period TP.

A data voltage Vdata synchronized with the pulse of the gate signal Vgate is applied to the data line DL during the display period DIS, and pulses having the same phase as those of the touch sensor driving signal LFD are applied to the data line DL during the touch sensing period TP. During the touch sensing period TP, the voltages of the pulses applied to the sensor line SL, the data line DL, and the gate line GL may be the same. Accordingly, when the touch sensor driving signal LFD is applied to the sensor line SL, there is almost no voltage difference between the sensor line and other signal lines DL and GL, and thus parasitic capacitance of the display panel PNL, which affects the touch sensor driving signal at the time of touch sensing, may be minimized.

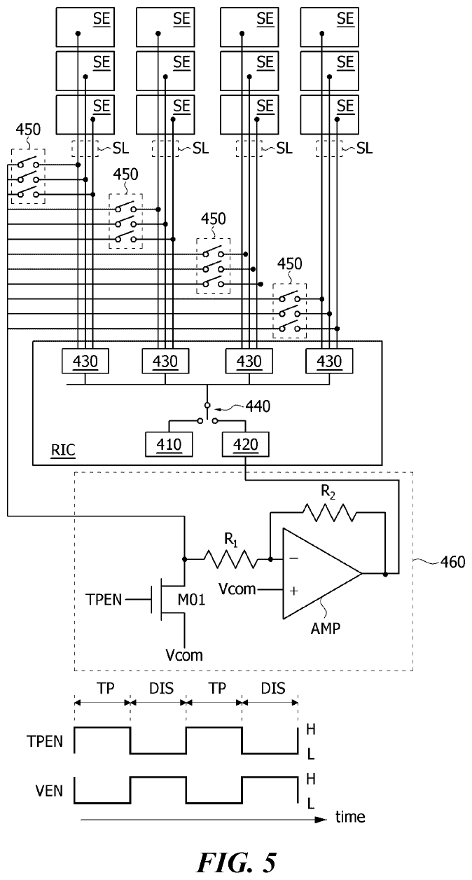

When the touch sensor driving signal LFD applied to the sensor lines SL during the touch sensing period TP is inputted to the voltage compensation circuit 460, a high-frequency signal generated as an inverted signal of the touch sensor driving signal LFD may flow through a wire connected to the output terminal of the voltage compensation circuit 460, thereby causing EMI noise. If the high-frequency signal outputted from the voltage compensation circuit 460 is applied to the sensor lines SL during the touch sensing period TP, the pulse voltage of the touch sensor driving signal LFD may decrease or its AC component may be removed, which may degrade the signal sensitivity of the in-cell touch sensor or cause malfunction. The present disclosure may, using the voltage compensation circuit 460 as shown in FIGS. 5 to 7, remove a ripple component applied to the common electrode SE during the display period DIS, and block the touch sensor driving signal LFD applied to the input terminal of the voltage compensation circuit during the touch sensing period TP, thereby preventing distortion of the pulses of the touch sensor driving signal LFD applied to the sensor lines.

FIG. 5 is a circuit diagram illustrating a voltage compensation circuit according to one embodiment of the present disclosure. In this embodiment, the same reference numerals are used for components that are substantially identical to those in the foregoing embodiment, and redundant descriptions thereof will be omitted.

Referring to FIG. 5, the voltage compensation circuit 460 includes a transistor M01 and an inverting amplifier. The inverting amplifier may include an operational amplifier AMP, an input resistor R₁ connected to an inverting input terminal (−) of the operational amplifier AMP, and a feedback resistor R₂ connected between the output terminal and the inverting input terminal (−) of the operational amplifier AMP, but is not limited thereto. The common voltage Vcom from the power supply 400 is applied to a non-inverting input terminal (+) of the operational amplifier AMP.

The transistor M01 may be an n-channel transistor, but is not limited thereto. The transistor M01 includes a gate electrode to which the touch enable signal TPEN is inputted, a first electrode connected to a node between the sensor lines SL and the input resistor R₁, and a second electrode to which the common voltage Vcom is inputted. The first electrode of the transistor M01 may be directly connected to one or more of the sensor lines SL, or may be connected to the sensor lines SL through one or more of the switching elements 450 that are turned on during the display period DIS.

The voltage of the voltage enable signal VEN, which controls the switching elements 450, is the second voltage L during the touch sensing period TP, and the first voltage H during the display period DIS. The voltage of the touch enable signal TPEN, which controls the transistor M01, is the first voltage H during the touch sensing period TP, and the second voltage L during the display period DIS.

The switching elements 450 are connected between the input resistor R₁ and the sensor lines SL, and are turned on/off in response to the voltage enable signal VEN. The switching elements 450 are turned on in response to the first voltage H of the voltage enable signal VEN during the display period DIS. When the switching elements 450 are turned on, the sensor lines SL are connected to one another and are connected to the input resistor R₁ of the voltage compensation circuit. During the touch sensing period TP, the switching elements 450 are turned off in response to the second voltage L of the voltage enable signal VEN. When the switching elements 450 are turned off, the sensor lines SL are electrically disconnected from each other and electrically disconnected from the input resistor R₁ of the voltage compensation circuit.

The input resistor R₁ of the voltage compensation circuit 460 is connected to the sensor lines SL during the display period DIS, but is electrically disconnected from the sensor lines SL and may be applied with a DC voltage during the touch sensing period TP. The voltage compensation circuit 460 amplifies, by a gain of the inverting amplifier, an inverted signal of noise caused by ripple of the common voltage Vcom inputted through the sensor lines SL during the display period DIS, and outputs the amplified signal. During the display period DIS, the inverted signal outputted from the voltage compensation circuit 460 is applied to the sensor lines SL through the sensor driver RIC.

The transistor M01 is turned on in response to the first voltage H of the touch enable signal TPEN during the touch sensing period TP, and applies the common voltage Vcom from the power supply 400 to the input resistor R₁ of the voltage compensation circuit. Accordingly, during the touch sensing period TP, the voltage compensation circuit amplifies, by a gain of the inverting amplifier, the common voltage Vcom without AC noise, i.e., a DC voltage and outputs the amplified voltage. When the gain of the inverting amplifier is ‘1,’ the inverting amplifier outputs the common voltage Vcom as received during the touch sensing period TP.

The transistor M01 is turned off in response to the second voltage L of the touch enable signal TPEN during the display period DIS. When the transistor M01 is turned off, the input resistor R₁ of the voltage compensation circuit is electrically disconnected from the second electrode of the transistor M01 to which the common voltage Vcom is applied.

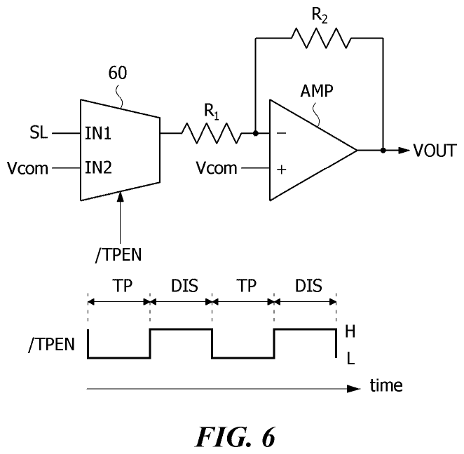

FIG. 6 is a circuit diagram illustrating a voltage compensation circuit according to another embodiment of the present disclosure. In this embodiment, the same reference numerals are used for components that are substantially identical to those in the foregoing embodiment, and redundant descriptions thereof will be omitted.

Referring to FIG. 6, the voltage compensation circuit 460 includes a multiplexer 60 and the inverting amplifier.

The multiplexer 60 includes a first input terminal IN1 connected to the sensor line SL, a second input terminal IN2 to which the common voltage Vcom from the power supply 400 is inputted, an output terminal connected to the input resistor R₁ of the inverting amplifier, and a control terminal to which the touch enable signal /PEN is inputted. The first input terminal IN1 may be directly connected to one or more of the sensor lines SL, or may be connected to the sensor lines SL through one or more of the switching elements 450 that are turned on during the display period DIS. The multiplexer 60 may reduce ripple generated during the switching of the transistor.

The multiplexer 60 connects the second input terminal IN2 to the output terminal in response to the second voltage L of the touch enable signal /PEN during the touch sensing period TP, thereby applying the common voltage Vcom to the input resistor R₁ of the voltage compensation circuit. The multiplexer 60 connects the first input terminal IN1 to the output terminal so as to connect the sensor lines SL to the input resistor R₁ in response to the first voltage H of the touch enable signal /PEN during the display period DIS. Accordingly, the inverting amplifier outputs an inverted signal of ripple of the common voltage Vcom applied to the sensor lines SL during the display period DIS, while outputting the common voltage Vcom during the touch sensing period TP. In FIG. 6, “VOUT” denotes the output voltage of the inverting amplifier.

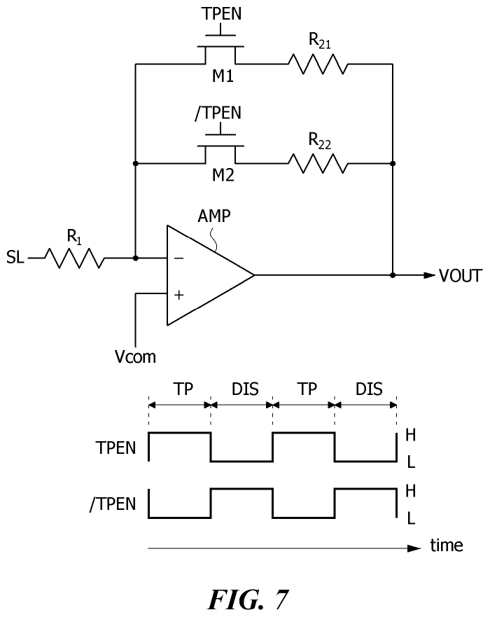

FIG. 7 is a circuit diagram illustrating a voltage compensation circuit according to still another embodiment of the present disclosure. In this embodiment, the same reference numerals are used for components that are substantially identical to those in the foregoing embodiment, and redundant descriptions thereof will be omitted.

Referring to FIG. 7, the inverting amplifier of the voltage compensation circuit 460 amplifies the inverted signal with a lower gain during the touch sensing period TP than during the display period DIS.

The inverting amplifier includes the operational amplifier AMP, the input resistor R₁ connected to the inverting input terminal (−) of the operational amplifier AMP, a first transistor M1 and a first feedback resistor R₂₁ connected in series between the output terminal and the inverting input terminal (−) of the operational amplifier AMP, and a second transistor M2 and a second feedback resistor R₂₂ connected in series between the output terminal and the inverting input terminal (−) of the operational amplifier AMP.

The gain of the inverting amplifier becomes smaller during the touch sensing period TP than during the display period DIS. To achieve this, the first feedback resistor R₂₁ may have a smaller resistance value than the second feedback resistor R₂₂. The resistance values of a resistor in the voltage compensation circuit may be R₁=1 kΩ, R₂₁=1 kΩ, and R₂₂=15 kΩ, but are not limited thereto. For example, R₂₁ may be a resistor having a resistance value smaller than 1 kΩ, and R₂₂ may be a resistor having a resistance value greater than 1 kΩ.

The first and second transistors M1 and M2 may be n-channel transistors, but are not limited thereto. The first transistor M1 includes a gate electrode to which the first touch enable signal TPEN is inputted, a first electrode connected to the inverting input terminal (−) of the operational amplifier AMP, and a second electrode connected to the first feedback resistor R₂₁. The first feedback resistor R₂₁ is connected between the second electrode of the first transistor M1 and the output terminal of the operational amplifier AMP. The second transistor M2 includes a gate electrode to which the second touch enable signal /PEN is inputted, a first electrode connected to the inverting input terminal (−) of the operational amplifier AMP, and a second electrode connected to the second feedback resistor R₂₂. The second feedback resistor R₂₂ is connected between the second electrode of the second transistor M2 and the output terminal of the operational amplifier AMP.

The first transistor M1 is turned on in response to the first voltage H of the first touch enable signal TPEN during the touch sensing period TP, thereby connecting the first feedback resistor R₂₁ to the inverting input terminal (−) of the operational amplifier AMP. In this case, a gain A of the inverting amplifier is A =R₂₁/R₁. The first transistor M1 is turned off in response to the second voltage L of the first touch enable signal TPEN during the display period DIS, thereby electrically disconnecting the first feedback resistor R₂₁ from the inverting input terminal (−) of the operational amplifier AMP.

The second transistor M2 is turned on in response to the first voltage H of the second touch enable signal /PEN during the display period DIS, thereby connecting the second feedback resistor R₂₂ to the inverting input terminal (−) of the operational amplifier AMP. In this case, the gain A of the inverting amplifier is A=R₂₂/R₁. The second transistor M2 is turned off in response to the second voltage L of the second touch enable signal /PEN during the touch sensing period TP, thereby electrically disconnecting the second feedback resistor R₂₂ from the inverting input terminal (−) of the operational amplifier AMP.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the detailed description of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A touch sensor driving circuit comprising:
a plurality of sensor lines;
a voltage compensation circuit electrically connected to the sensor lines; and
a sensor driver configured to supply a pulse of a touch sensor driving signal to the sensor lines during a first period, and to supply an output voltage of the voltage compensation circuit to the sensor lines during a second period,
wherein the voltage compensation circuit includes an input resistor configured to be electrically connected to the sensor lines during the second period.

2. The touch sensor driving circuit of claim 1, wherein the input resistor is configured to receive a DC voltage during the first period.

3. The touch sensor driving circuit of claim 2, further comprising:
a plurality of switching elements connected to the sensor lines,
wherein the switching elements are configured to be turned on during the second period to connect the sensor lines to each other and to connect the sensor lines to the input resistor.

4. The touch sensor driving circuit of claim 3, wherein the switching elements are configured to be turned off to electrically disconnect the sensor lines from each other and to electrically disconnect the sensor lines from the input resistor during the first period.

5. The touch sensor driving circuit of claim 1, wherein the voltage compensation circuit includes:
an operational amplifier including an inverting input terminal connected to the input resistor, a non-inverting input terminal configured to receive the DC voltage, and an output terminal connected to the sensor driver; and
a feedback resistor connected between the inverting input terminal and the output terminal of the operational amplifier.

6. The touch sensor driving circuit of claim 5, wherein the voltage compensation circuit includes:
a transistor configured to be turned on to supply a DC voltage to the input resistor during the first period and to be turned off during the second period in response to a touch enable signal.

7. The touch sensor driving circuit of claim 6, wherein the transistor includes:
a gate electrode configured to receive the touch enable signal, a first electrode connected to a node between the sensor lines and the input resistor, and a second electrode configured to receive the DC voltage.

8. The touch sensor driving circuit of claim 5, wherein the voltage compensation circuit includes:
a multiplexer configured to supply the DC voltage to the input resistor during the first period and to connect the sensor lines to the input resistor during the second period in response to a touch enable signal.

9. A touch sensor driving circuit comprising:
a plurality of sensor lines;
an inverting amplifier electrically connected to the sensor lines; and
a sensor driver configured to supply a pulse of a touch sensor driving signal to the sensor lines during a first period, and to supply an output voltage of the inverting amplifier to the sensor lines during a second period.

10. The touch sensor driving circuit of claim 9, wherein a gain of the inverting amplifier is configured to be lower in the first period than in the second period.

11. The touch sensor driving circuit of claim 10, wherein the inverting amplifier includes:
an input resistor electrically connected to the sensor lines;
an operational amplifier including an inverting input terminal connected to the input resistor, a non-inverting input terminal configured to receive a DC voltage, and an output terminal;
a first transistor and a first feedback resistor connected in series between the output terminal and the inverting input terminal of the operational amplifier; and
a second transistor and a second feedback resistor connected in series between the output terminal and the inverting input terminal of the operational amplifier.

12. The touch sensor driving circuit of claim 11, wherein:
a resistance value of the first feedback resistor is smaller than that of the second feedback resistor,
the first transistor is configured to be turned on during the first period to connect the first feedback resistor to the inverting input terminal, and
the second transistor is configured to be turned on during the second period to connect the second feedback resistor to the inverting input terminal.

13. A display device comprising:
a display panel in which a plurality of data lines, a plurality of gate lines, a plurality of sensor lines, a plurality of pixels, a plurality of divided electrodes connected to the pixels and the sensor lines, and a plurality of in-cell touch sensors connected to the sensor lines are arranged;
a voltage compensation circuit electrically connected to the sensor lines;
a sensor driver configured to supply a pulse of a touch sensor driving signal to the sensor lines during a first period, and supply an output voltage of the voltage compensation circuit to the sensor lines during a second period; and
a pixel driver configured to supply a data voltage of pixel data to the data lines during the second period,
wherein the voltage compensation circuit includes an input resistor configured to be electrically connected to the sensor lines during the second period.

14. The display device of claim 13, wherein the input resistor is configured to receive a DC voltage during the first period.

15. The display device of claim 13, wherein the display panel includes:
a plurality of switching elements connected to the sensor lines, and
wherein the switching elements are configured to be turned on during the second period to connect the sensor lines to each other and to connect the sensor lines to the input resistor, and are configured to be turned off to electrically disconnect the sensor lines from each other and to electrically disconnect the sensor lines from the input resistor during the first period.

16. The display device of claim 13, wherein the voltage compensation circuit includes:
an operational amplifier including an inverting input terminal connected to the input resistor, a non-inverting input terminal configured to receive a DC voltage, and an output terminal connected to the sensor driver; and
a feedback resistor connected between the inverting input terminal and the output terminal of the operational amplifier.

17. The display device of claim 16, wherein the voltage compensation circuit includes:
a transistor configured to be turned on to supply the DC voltage to the input resistor during the first period and to be turned off during the second period in response to a touch enable signal.

18. The display device of claim 16, wherein the voltage compensation circuit includes:
a multiplexer configured to supply the DC voltage to the input resistor during the first period and configured to connect the sensor lines to the input resistor during the second period in response to a touch enable signal.
